(19) United States
(12) Patent Application Publication
(10) Pub. No.: US 2023/0416992 A1
(43) Pub. Date: Dec. 28, 2023

(54) BARRIER FILM FOR PACKAGING MATERIAL

(71) Applicant: Stora Enso OYJ, Helsinki (FI)

(72) Inventors: Isto Heiskanen, Imatra (FI); Kaj Backfolk, Lappeenranta (FI); Katja Lyytikäinen, Imatra (FI); Jukka Kankkunen, Imatra (FI)

(73) Assignee: Stora Enso OYJ, Helsinki (FI)

(21) Appl. No.: 18/253,251

(22) PCT Filed: Nov. 17, 2021
(86) PCT No.: PCT/IB2021/060639

§ 371 Date: May 17, 2023

(30) Foreign Application Priority Data
Nov. 18, 2020 (SE) 2051348-7

(51) Int. Cl. D21H 19/82; D21H 11/18; D21H 17/36; D21H 19/12; D21H 19/08; D21H 21/16; D21H 23/72; D21H 23/50; D21H 23/46; D21H 27/10; D21H 27/30; B65D 65/40; B32B 29/00

(52) U.S. Cl. CPC D21H 19/82; D21H 11/18; D21H 17/36; D21H 19/12; D21H 19/08; D21H 21/16; D21H 23/72; D21H 23/50; D21H 23/46; D21H 27/10; D21H 27/30; B65D 65/40; B32B 29/005; B65D 2565/387; B32B 2255/12; B32B 2255/26; B32B 2255/205; B32B 2255/28; B32B 2307/7244; B32B 2307/7246; B32B 2307/718; B32B 2553/00; B32B 2439/00

(57) ABSTRACT

The present invention relates to a barrier film for a paper or paperboard-based packaging material, said barrier film comprising: a substrate; a vacuum coating layer having a thickness in the range of 1-500 nm disposed on the substrate; and a protective coating layer comprising a crosslinked water-soluble polymer disposed on the vacuum coating layer. The present invention further relates to a paper or paperboard based packaging material and containers comprising the barrier film, and to a method for manufacturing the barrier film.

### TECHNICAL FIELD

The present disclosure relates to barrier films for paper and paperboard based packaging materials. More specifically, the present disclosure relates to barrier films based on microfibrillated cellulose having a good and stable oxygen transmission rate (OTR) at high relative humidities (RH). The present invention further relates to paper and paperboard based packaging materials comprising such barrier films and to methods for manufacturing such barrier films.

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board. In liquid packaging board, polyolefin coatings are frequently used as liquid barrier layers, heat sealing layers and adhesives. However, the recycling of such polymer coated board is difficult since it is difficult to separate the polymers from the fibers.

In many cases the gas barrier properties of the polymer coated paperboard are still insufficient. Therefore, in order to ensure acceptable gas barrier properties the polymer coated paperboard is often provided with one or more layers of aluminum foil. However, the addition of polymer and aluminum layers add significant costs and makes recycling of the materials more difficult. Also, due to its high carbon footprint there is a wish to replace aluminum foils in packaging materials in general, and in liquid packaging board in particular.

More recently, microfibrillated cellulose (MFC) films and coatings have been developed, in which defibrillated cellulosic fibrils have been dispersed e.g. in water and thereafter re-organized and rebonded together to form a dense film with excellent gas barrier properties. Unfortunately, the gas barrier properties of such MFC films tend to deteriorate at high temperatures and high humidity.

Many approaches for improving the gas barrier properties towards oxygen, air, and aromas at high relative humidity have been investigated and described, but most of the suggested solutions are expensive and difficult to implement on an industrial scale. One route is to modify the MFC or nanocellulose such as disclosed in EP2554589A1 where an MFC dispersion was modified with a silane coupling agent. Another patent application, EP2551104A1, teaches the use of MFC and polyvinyl alcohol (PVOH) and/or polyuronic acid with improved barrier properties at higher relative humidity. Another solution is to coat the film with a layer that has high water fastness and/or low water vapor transmission rate. JP2000303386A discloses, e.g., latex coated on MFC film, while US2012094047A suggests the use of wood hydrolysates mixed with polysaccharides such as MFC that can be coated with a polyolefin layer. In addition to these methods, the possibility of crosslinking fibrils or fibrils and copolymers has been investigated. This improves water fastness of the films but also water vapor transmission rates. EP2371892A1 and EP2371893A1 describe crosslinking of MFC with metal ions, glyoxal, glutaraldehyde and/or citric acid, respectively.

Another way to decrease the moisture sensitivity of cellulose is to chemically modify the cellulose with sodium periodate to obtain dialdehyde cellulose (DAC). By fibrillation of dialdehyde cellulose, a barrier film with improved moisture resistance can be produced. However, a dispersion comprising microfibrillated dialdehyde cellulose (DA-MFC) is very unstable since the DA-MFC sediments and spontaneously crosslinks to certain degree already in the dispersion, causing the microfibrils to be bound or entangled. The poor stability of the dispersion results in variations of the concentration of DA-MFC in the film leading to poor film formation and barrier properties.

Thus, there remains a need for improved solutions to replace plastic films and aluminum foils in packaging materials, while maintaining acceptable liquid and oxygen barrier properties. At the same time, there is a need to replace the plastic films and aluminum foils with alternatives that facilitate re-pulping and recycling of the used packaging materials.

### DESCRIPTION OF THE INVENTION

It is an object of the present disclosure to provide an alternative to the plastic films and aluminum foils commonly used as barrier films for providing liquid and oxygen barrier properties in packaging materials, such as liquid packaging board.

It is a further object of the present disclosure to provide a barrier film for paper or paperboard based packaging materials and liquid packaging board, which facilitates re-pulping of the board.

It is a further object of the present disclosure, to provide a barrier film comprising microfibrillated cellulose, which has improved barrier properties even at higher relative humidity and temperature.

It is a further object of the present disclosure to provide a barrier film for paper or paperboard based packaging materials, which has an oxygen transfer rate (OTR), measured according to the standard ASTM D-3985 at 85% relative humidity and 38° C., of less than 10 cc/m²/day, and preferably less than 5 cc/m²/day.

It is a further object of the present disclosure to provide a paper or paperboard based packaging material without an aluminum foil having a reject rate according to PTS RH 021/97 of less than 30%, preferably less than 20%.

The above-mentioned objects, as well as other objects as will be realized by the skilled person in the light of the present disclosure, are achieved by the various aspects of the present disclosure.

According to a first aspect illustrated herein, there is provided a barrier film for a paper or paperboard-based packaging material, said barrier film comprising:
a substrate;
a vacuum coating layer having a thickness in the range of 1-500 nm disposed on the substrate; and
a protective coating layer comprising a crosslinked water-soluble polymer disposed on the vacuum coating layer.

The invention is based on the realization that a combination of a thin vacuum coating layer and a thin protective coating layer comprising a crosslinked water-soluble polymer disposed on the vacuum coating layer can improve the barrier properties of a substrate enough to allow the coated substrate to replace or significantly reduce conventional plastic films and aluminum foils in packaging materials.

A problem with thin vacuum coatings is that they are easily damaged. The protective coating layer comprising a crosslinked water-soluble polymer disposed on the vacuum coating layer protects the vacuum coating and helps to prevent damage to the coating during handling of the film. The inventive solution also allows the film to be produced at one location and then transported to a second location with less risk of damaging the coated surface.

The protective coating layer comprising a crosslinked water-soluble polymer disposed on the vacuum coating layer protects the vacuum coating while having a low negative impact on re-pulping and recycling of the used barrier film. The combination of a thin vacuum coating layer and a thin protective coating layer comprising a crosslinked water-soluble polymer can facilitate re-pulping and recycling of the used barrier film and packaging materials comprising the barrier film.

The substrate of the present invention may be any substrate suitable for applying a continuous of substantially continuous vacuum coating layer having a thickness in the range of 1-500 nm thereon. The substrate preferably comprises a film or sheet shaped material having a smooth, dense and relatively low porous surface on which the vacuum coating can be applied. The substrate should preferably have few or no pinholes. The amount of pinholes in a film or sheet shaped substrate may for example be determined according to standard EN13676:2001.

The substrate may consist of a single layer of material or it can be a multilayer structure comprised of two or more layers of the same or different materials. The substrate may for example comprise or consist of a polymer film formed from synthetic or biobased polymers. Alternatively, the substrate may comprise or consist of a dense sheet of a fiber based material. The substrate may also comprise or consist of a combination of a fiber based material and a synthetic or biobased polymer, e.g. in the form of a laminate or a polymer coated paper or a composite. In some embodiments the substrate comprises or consists of a mixture of fibers and a polymer. In some embodiments the substrate comprises one layer of a fiber based material and one layer of a polymer. For example, the substrate can consist of a fiber based layer, for example a microfibrillated cellulose (MFC) film, coated with a polymer layer, for example a polyvinyl alcohol (PVOH) coating to improve the smoothness and decrease the porosity of the MFC film surface.

In some embodiments, the substrate comprises a high density paper, such as a supercalandered paper formed from chemical pulp or mechanical pulp or a mixture thereof, which has subsequently been coated or laminated with a MFC film or layer to provide a surface suitable for applying a continuous of substantially continuous vacuum coating layer having a thickness in the range of 1-500 nm thereon.

In some embodiments, the substrate comprises less than 10 pinholes/m², preferably less than 8 pinholes/m², and more preferably less than 2 pinholes/m². The amount of pinholes per m 2 may for example be measured by optical inspection, for example according to standard EN13676:2001.

The substrate is preferably biobased and more preferably cellulose based. By biobased or cellulose based is meant that more than 50% by weight of the substrate is of natural, or preferably cellulosic origin. Using a cellulose based substrate is especially useful for barrier films for use in paper or paperboard laminates since the laminate can be recycled as a single material.

MFC has been identified as an interesting component for use in barrier films for paper and paperboard packaging materials. MFC films have been found to provide low oxygen transfer rates at conditions of intermediate temperature and humidity, e.g. at 50% relative humidity and 23° C. Unfortunately, the gas barrier properties of such MFC films tend to deteriorate significantly at higher temperatures and humidities, e.g. at 85% relative humidity and 38° C., rendering the films unsuitable for many industrial food and liquid packaging applications.

The present inventors have now found that these deficiencies of prior art films comprising MFC can be remedied by a barrier film comprising a MFC layer, at least one surface of which has been metallized by vacuum coating such that a thin vacuum coating layer is formed on the surface of the MFC layer, and a protective coating layer comprising a crosslinked water-soluble polymer disposed on the vacuum coating layer.

A barrier film comprising a MFC layer provided with a vacuum coating layer and a protective coating layer comprising a crosslinked water-soluble polymer provides both excellent oxygen barrier properties, water vapor barrier properties, and liquid barrier properties. Especially remarkable is the combination of high oxygen barrier properties and high water vapor barrier properties such films exhibit at high humidity and temperature. The term high humidity in the context of the present disclosure generally refers to a relative humidity (RH) above 80%. The term high temperature in the context of the present disclosure generally refers to a temperature above 23° C. More specifically, the term high temperature in the context of the present disclosure may refer to a temperature in the range of 25-50° C. Oxygen barrier and water vapor barrier properties of the films at high humidity and temperature are typically measured at a representative relative humidity (RH) of 85% and a temperature of 38° C.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

A paper or paperboard-based packaging material is a packaging material formed mainly, or entirely from paper or paperboard. In addition to paper or paperboard, the paper or paperboard-based packaging material may comprise additional layers or coatings designed to improve the performance and/or appearance of the packaging material.

The inventive barrier film can be used to manufacture a paper or paperboard based packaging material having an oxygen transfer rate (OTR), measured according to the standard ASTM D-3985 at 85% relative humidity and 38° C., less than 10 cc/m²/day, and preferably less than 5 cc/m²/day.

The inventive barrier film can further be used to manufacture a paper or paperboard based packaging material which is recyclable and may provide a reject rate according to PTS RH 021/97 of less than 30%, preferably less than 20%, more preferably less than 10%.

This makes the inventive barrier film an interesting and viable alternative to the aluminum foil layer commonly used in liquid packaging board for providing liquid and gas barrier properties.

The inventive barrier film is further advantageous in that it can be realized without any extrusion coated or lamination coated polyolefin coatings often used in barrier layers for liquid packaging materials. Instead, the inventive barrier film uses a thin protective coating comprising a crosslinked water-soluble polymer disposed on the vacuum coating layer.

In some embodiments, the substrate consists of or comprises a microfibrillated cellulose layer (MFC layer). In other words, the substrate can be made up entirely of the MFC layer, or it can include the MFC layer as one of several layers.

Microfibrillated cellulose (MFC) shall in the context of the patent application be understood to mean a nano scale cellulose particle fiber or fibril with at least one dimension less than 1000 nm. MFC comprises partly or totally fibrillated cellulose or lignocellulose fibers. The liberated fibrils typically have a diameter less than 1000 nm, whereas the actual fibril diameter or particle size distribution and/or aspect ratio (length/width) depends on the source and the manufacturing methods. The smallest fibril is called elementary fibril and has a diameter of approximately 2-4 nm (see e.g. Chinga-Carrasco, G., Cellulose fibres, nanofibrils and microfibrils: The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3), is the main product that is obtained when making MFC e.g. by using an extended refining process or pressure-drop disintegration process. Depending on the source and the manufacturing process, the length of the fibrils can vary from around 1 to more than 10 micrometers, A coarse MFC grade might contain a substantial fraction of fibrillated fibers, i.e. protruding fibrils from the tracheid (cellulose fiber), and with a certain amount of fibrils liberated from the tracheid (cellulose fiber).

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physical or physical-chemical properties such as its large surface area or its ability to form a gel-like material at low solids (1-5 wt %) when dispersed in water.

Various methods exist to make MFG, such as single or multiple pass refining, pre-hydrolysis followed by refining or high shear disintegration or liberation of fibrils. One or several pre-treatment steps are usually required in order to make MFC manufacturing both energy efficient and sustainable. The cellulose fibers of the pulp to be utilized may thus be pre-treated, for example enzymatically or chemically, to hydrolyse or swell the fibers or to reduce the quantity of hemicellulose or lignin. The cellulose fibers may be chemically modified before fibrillation, such that the cellulose molecules contain other (or more) functional groups than found in the native cellulose. Such groups include, among others, carboxymethyl, aldehyde and/or carboxyl groups (cellulose obtained by N-oxyl mediated oxidation, for example “TEMPO”), quaternary ammonium (cationic cellulose) or phosphoryl groups. After being modified or oxidized in one of the above-described methods, it is easier to disintegrate the fibers into MFC or nanofibrils.

The nanofibrillar cellulose may contain some hemicelluloses, the amount of which is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, fluidizer such as microfluidizer, macrofluidizer or fluidizer-type homogenizer. Depending on the MFC manufacturing method, the product might also contain fines, or nanocrystalline cellulose, or other chemicals present in wood fibers or in papermaking process. The product might also contain various amounts of micron size fiber particles that have not been efficiently fibrillated.

MFC is produced from wood cellulose fibers, both from hardwood and softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

The MFC of the MFC layer of the inventive barrier film may be unmodified MFC or chemically modified MFC, or a mixture thereof. In some embodiments, the MFC is an unmodified MFC. Unmodified MFC refers to MFC made of unmodified or native cellulose fibers. The unmodified MFC may be a single type of MFC, or it can comprise a mixture of two or more types of MFC, differing e.g, in the choice of cellulose raw material or manufacturing method. Chemically modified MFC refers to MFC made of cellulose fibers that have undergone chemical modification before, during or after fibrillation. In some embodiments, the MFC is a chemically modified MFC. The chemically modified MFC may be a single type of chemically modified MFC, or it can comprise a mixture of two or more types of chemically modified MFC, differing e.g. in the type of chemical modification, the choice of cellulose raw material or the manufacturing method.

The MFC layer may be comprised solely of MFC, or it can comprise a mixture of MFC and other ingredients or additives. The MFC layer of the inventive barrier film preferably includes MFC as its main component based on the total dry weight of the MFC layer. In some embodiments, the MFC layer comprises at least 50 wt %, preferably at least 70 wt %, more preferably at least 80 wt % MFC, based on the total dry weight of the MFC layer.

The formulation of the MFC layer may vary depending on the intended use and on other layers present in the substrate. The formulation of the MFC layer may also vary depending on the intended mode of application or formation of the MFC layer, e.g. coating of a MFC dispersion onto another substrate layer or onto a paper or paperboard base layer, or formation of a free standing MFC film. The MFC layer may include a wide range of ingredients in varying quantities to improve the end performance of the film or processing of the MFC dispersion. The MFC layer may for example further comprise additives such as starch, carboxymethyl cellulose, a filler, retention chemicals, flocculation additives, deflocculating additives, dry strength additives, softeners, or mixtures thereof. The MFC layer may further comprise additives that will improve different properties of the mixture and/or the produced film, such as latex and/or polyvinyl alcohol (PVOH) for enhancing the ductility of the film.

In some embodiments, the MFC layer further comprises a polymeric binder. In some embodiments, the MFC layer further comprises PVOH. The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 88-99 mol %. Furthermore, the PVOH may preferably have a viscosity above 5 mPa×s in a 4% aqueous solution at 20° C. DIN 53015/JIS K 6726.

In some embodiments, the MFC layer further comprises a pigment. The pigment may for example comprise inorganic particles of talcum, silicates, carbonates, alkaline earth metal carbonates and ammonium carbonate, or oxides, such as transition metal oxides and other metal oxides. The pigment may also comprise nano-size pigments such as nanoclays and nanoparticles of layered mineral silicates, for instance selected from the group comprising montmorillonite, bentonite, kaolinite, hectorite and hallyosite. By nanoparticles it is meant a pigment composition where at least 60 wt % of the particles have a diameter of less than 100 nm, e.g. as determined by laser diffraction.

In some preferred embodiments, the pigment is selected from the group consisting of nanoclays and nanoparticles of layered mineral silicates, more preferably bentonite.

The basis weight (corresponding to the thickness) of the MFC layer of the inventive barrier film is preferably in the range of less than 55 gsm (grams per square meter). The basis weight of the MFC layer may for example depend on the mode of its manufacture. For example, coating of a MFC dispersion onto another substrate layer may result in a thinner layer, whereas the formation of a free standing MFC film may require a thicker layer. In some embodiments, the basis weight of the MFC layer is in the range of 5-50 gsm. In some embodiments, the basis weight of the MFC layer is in the range of 5-20 gsm.

A fibrous or porous substrate layer, e.g. a MFC layer, may preferably be combined with a surface treatment to improve the smoothness and decrease the porosity of the substrate surface and make the surface more suitable for applying a continuous of substantially continuous vacuum coating layer having a thickness in the range of 1-500 nm thereon. Possible surface treatments include, but are not limited to providing the surface with a smoothening precoat or mechanical smoothening, e.g. by calandering.

The surface treatment may for example include applying a precoat layer to the fibrous or porous substrate layer. The precoat layer preferably acts to level out unevenness, and fill pores and pinholes present in the fibrous or porous substrate layer.

Calandering may include hard nip or soft nip calandering in one or several passes or nips. The mechanical smoothening can also be combined with a precoating step, performed before or after the calandering.

Thus, in some embodiments, the substrate further comprises a precoat layer disposed between the MFC layer and the vacuum coating layer.

In some embodiments, the precoat layer comprises a water-soluble polymer selected from the group consisting of a polyvinyl alcohol, a modified polyvinyl alcohol, a polysaccharide and a modified polysaccharide, or combinations thereof, preferably polyvinyl alcohol.

The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPaxs in a 4% aqueous solution at 20° C. DIN 53015/JIS K 6726 (with no additives and with no change in pH, i.e. as obtained when dispersed and dissolved e.g. in distilled water). Examples of useful products are, e.g., Kuraray Poval 4-98, Poval 6-98, Poval 10-98, Poval 20-98, Poval 30-98, or Poval 56-98 or mixtures of these. From the less hydrolysed grades, the Poval 4-88, Poval 6-88, Poval 8-88, Poval 18-88, Poval 22-88, or e.g. Poval 49-88 are preferred.

The modified polysaccharide may for example be a modified cellulose, such as carboxymethylcellulose (CMC) or hydroxypropyl cellulose (HPC), or a modified starch, such as a hydroxyalkylated starch, a cyanoethylated starch, a cationic or anionic starch, or a starch ether or a starch ester. Some preferred modified starches include hydroxypropylated starch, hydroxyethylated starch, dialdehyde starch and carboxymethylated starch.

In some embodiments, the basis weight of the precoat layer is in the range of 0.1-12 gsm, preferably in the range of 0.5-8 gsm, more preferably in the range of 1-6 gsm.

To minimize the risk of pinholes in the precoat layer, the precoat layer may preferably be applied in at least two different coating steps with drying of the coated film between the steps.

The precoat layer can be applied by contact or non-contact coating methods. For application on MFC layers, non-contact coating methods are typically preferred to minimize the risk of damage to the substrate during coating. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating. In some embodiments, the coating is applied in the form a foam. Foam coating is advantageous as it allows for film forming at higher solids content and lower water content compared to an unfoamed coating. The lower water content of a foam coating also reduces the problems with rewetting of the MFC layer.

Vacuum coating refers to a family of processes used to deposit layers of material atom-by-atom or molecule-by-molecule on a solid surface. These processes operate at pressures well below atmospheric pressure (i.e. under vacuum). The deposited layers can range from a thickness of one atom up to millimeters, although in the present context, the coating layer should have a thickness in the range of 1-500 nm. Multiple layers of the same or different materials can be combined. The process can be further specified based on the vapor source; physical vapor deposition (PVD) uses a liquid or solid source and chemical vapor deposition (CVD) uses a chemical vapor.

In some embodiments, the vacuum coating layer is formed by vapor deposition of a metal or metal oxide on the substrate, preferably by physical vapor deposition (PVD) or chemical vapor deposition (CVD).

In a preferred embodiment, the “vacuum coating layer” is a thin layer of metal or metal oxide providing barrier properties reducing permeability to e.g. oxygen or other gases or aromas, water, water vapor and light.

In some embodiments, only one of the surfaces of the substrate has been subjected to vacuum coating. In some embodiments, both surfaces of the substrate have been subjected to vacuum coating.

In some embodiments, the vacuum coating layer is formed by vapor deposition of a metal or metal oxide on the substrate, preferably by physical vapor deposition (PVD) or chemical vapor deposition (CVD), more preferably by physical vapor deposition (PVD).

The vacuum coating layer of the present invention is preferably comprises a metal or metal oxide. Vacuum coating of a metal or metal oxide is often also referred to as metallization, and a vacuum coating layer of a metal or metal oxide can also be referred to as a “metallization layer”.

Metallized papers, paperboards, films and foils offer highly attractive finishes that maximize the shelf appeal of products. Metallized substrates be used for a wide range of packaging and label applications.

In some embodiments, the vacuum coating layer comprises a metal or metal oxide selected from the group consisting of aluminum, magnesium, silicon, copper, aluminum oxides, magnesium oxides, silicon oxides, and combinations thereof, preferably an aluminum oxide. Aluminum oxide vacuum coatings also known as AlOx coatings can provide similar barrier properties as aluminum metal coatings, but have the added advantage of thin AlOx coatings being transparent to visible light.

Thin vacuum deposited layers are normally merely nanometer-thick, i.e. have a thickness in the order of magnitude of nanometers. The vacuum coating layer of the present invention has a thickness in the range of from 1 to 500 nm. In some embodiments, the vacuum coating layer has a layer thickness in the range of 10-100 nm, preferably in the range of 20-50 nm.

One type of vapor deposition coating, sometimes used for its barrier properties, in particular water vapor barrier properties, is an aluminum metal physical vapor deposition (PVD) coating. Such a coating, substantially consisting of aluminum metal, may typically have a thickness of from 10 to 50 nm. The thickness of the metallization layer which corresponds to less than 1% of the aluminum metal material typically present in an aluminum foil of conventional thickness for packaging, i.e. 6.3 μm.

In some embodiments, the vacuum coating layer has a basis weight in the range of 50-250 mg/m², preferably in the range of 75-150 mg/m².

While thin vacuum coatings, or metallization coatings, require significantly less material than other coating methods, they normally only provide a low level of oxygen barrier properties and need to be combined with a further gas barrier material in order to provide a final laminated material with sufficient barrier properties.

In the inventive barrier film, a protective coating layer is disposed on the vacuum coating layer. The protective coating layer comprises a crosslinked water-soluble polymer formed by applying an aqueous solution or dispersion of the water-soluble polymer to the vacuum coating layer surface and crosslinking the water-soluble polymer on the surface using a crosslinking agent. The crosslinking agent can be included in the aqueous polymer solution or dispersion when it is applied, or it can be applied separately to the substrate before or after the aqueous polymer solution or dispersion has been applied to the vacuum coating layer surface.

The water-soluble polymer of the protective coating layer is soluble in cold water or soluble in water after heating to a temperature below 100° C. for a given period of time. The crosslinking of the water-soluble polymer will reduce its solubility in water.

The water-soluble polymer of the protective coating layer preferably comprises free hydroxyl functional groups. The water-soluble polymer may for example be selected from the group consisting of vinyl alcohol-based polymers, such as PVOH or water dispersible EVOH, acrylic acid or methacrylic acid based polymers (PAA, PMAA), polysaccharides such as for example starch or starch derivatives, proteins, cellulose nanofibrils (CNF), nanocrystalline cellulose (NCC), chitosan, hemicellulose, or combinations of two or more thereof. In some embodiments, the water-soluble polymer is anionic carboxymethyl cellulose (CMC).

In some embodiments, the water-soluble polymer of the protective coating layer is selected from the group consisting of a polyvinyl alcohol, a modified polyvinyl alcohol, a polysaccharide and a modified polysaccharide, or combinations thereof, preferably a polyvinyl alcohol.

The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPaxs in a 4% aqueous solution at 20° C. DIN 530151 JIS K 6726 (with no additives and with no change in pH, i.e. as obtained when dispersed and dissolved e.g. in distilled water). Examples of useful products are, e.g., Kuraray Poval 4-98, Poval 6-98, Poval 10-98, Poval 20-98, Poval 30-98, or Poval 56-98 or mixtures of these. From the less hydrolysed grades, Poval 4-88, Poval 6-88, Poval 8-88, Poval 18-88, Poval 22-88, or e.g. Poval 49-88 are preferred. The PVOH preferably has an ash content of less than 0.9 wt %, preferably less than 0.7 wt %, less than 0.4 wt % or less than 0.2 wt %.

The modified polysaccharide may for example be a modified cellulose, such as carboxymethylcellulose (CMC) or hydroxypropyl cellulose (HPC), or a modified starch, such as a hydroxyalkylated starch, a cyanoethylated starch, a cationic or anionic starch, or a starch ether or a starch ester. Some preferred modified starches include hydroxypropylated starch, hydroxyethylated starch, dialdehyde starch and carboxymethylated starch.

The protective coating layer is preferably applied by means of a liquid film coating process, i.e. in the form of an aqueous solution or dispersion which, on application, is spread out to a thin, uniform layer on the substrate and thereafter dried. The protective coating layer can be applied by contact or non-contact coating methods.

For application on the sensitive vacuum coating layer, non-contact coating methods or soft application and levelling of coating are typically preferred to minimize the risk of damage to the vacuum coating layer during coating. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating.

In some embodiments, the coating is applied in the form a foam. Foam coating is advantageous as it allows for film forming at higher solids content and lower water content compared to an unfoamed coating. The lower water content of a foam coating also reduces the problems with rewetting of the MFC layer. The foam may be formed using a polymeric or non-polymeric foaming agent. Examples of polymeric foaming agents include PVOH, hydrophobically modified starch, and hydrophobically modified ethyl hydroxyethyl cellulose. In some embodiments, the water-soluble polymer of the protective coating layer, e.g. PVOH, also acts as the polymeric foaming agent. An example of a non-polymeric foaming agent is sodium dodecyl sulfate (SDS).

The water-soluble polymer of the protective coating layer is crosslinked by a crosslinking agent. Various crosslinking agents can be used depending on the water-soluble polymer in question.

Crosslinking the water-soluble polymer improves both the mechanical and chemical stability for the coating layer, enhancing the protection of the sensitive vacuum coating layer. The crosslinking achieved by the crosslinking agent should preferably be covalent crosslinking. The crosslinking agent preferably comprises at least two functional groups capable of forming covalent bonds to functional groups present in the water-soluble polymer. The crosslinking may for example involve the formation of ester bonds, ether bonds, amide bonds between the functional groups of the crosslinking agent and the water-soluble polymer. The amount of crosslinker can be selected depending on the desired degree of crosslinking. Crosslinking may further be initiated or facilitated by using temperature, pH, a catalyst, or radiation (e.g. UV light radiation). The skilled person can identify suitable crosslinking agents and amounts depending on the type of water-soluble polymer and other circumstances.

One group of crosslinking agents which has been found especially useful in the barrier films of the present invention are multifunctional carboxylic acids, e.g. difunctional, trifunctional or polyfunctional carboxylic acids, or mixtures thereof. These crosslinking agents are water-soluble, typically have low or no toxicity, and have been bound to interact favorably with metal or metal oxide based vacuum coating layers, leading to further improved adhesion and protective properties. Examples of suitable multifunctional carboxylic acid crosslinking agents include, but are not limited to as citric acid, malic acid, succinic acid, tartaric acid, and 1,2,3,4-butanetetracarboxylic acid.

Thus, in some embodiments, the water-soluble polymer of the protective coating layer is crosslinked by a multifunctional carboxylic acid crosslinking agent. In some embodiments, the multifunctional carboxylic acid is selected from the group consisting of citric acid, malic acid, succinic acid, tartaric acid, and 1,2,3,4-butanetetracarboxylic acid, or a combination thereof. In a preferred embodiment, the multifunctional carboxylic acid is citric acid.

It is also possible to use a higher molecular weight polycarboxylic acid as the crosslinking agent. Examples of such higher molecular weight polycarboxylic acids include, but are not limited to polymaleic acid and poly(methyl vinyl ether-co-maleic acid).

The amount of the crosslinking agent in the protective coating layer is preferably in the range of 5-50 wt % based on the weight of the water-soluble polymer, more preferably in the range of 10-40 wt % based on the weight of the water-soluble polymer.

The basis weight of the protective coating layer may generally be in the range of 0.1-20 gsm. However, an advantage of the protective coating layer of the invention is that it provides good protective properties even at very low grammages. This is important for maintaining good repulpability and recyclability of the coated substrates. Thus, in some embodiments the basis weight of the protective coating layer is in the range of 0.1-12 gsm, preferably in the range of 0.5-8 gsm, more preferably in the range of 1-6 gsm.

To minimize the risk of pinholes in the protective coating layer, the protective coating layer may preferably be applied in at least two different coating steps with drying of the coated film between the steps. At least the layer in direct contact with the vacuum coating layer is crosslinked. As an example, in a first coating step, PVOH and citric acid is applied at a dry basis weight of about 1-5 gsm, dried and cured, and in a second coating step, PVOH is applied at a dry basis weight of about 1-5 gsm and dried.

The inventive barrier films are intended for use as gas barrier films in paper and paperboard packaging materials. The combination of the vacuum coating layer and the protective coating layer comprising a crosslinked water-soluble polymer has been found to provide the barrier film with excellent gas barrier properties and water vapor barrier properties.

In some embodiments, the barrier film has an oxygen transfer rate (OTR), measured according to the standard ASTM D-3985 at 50% relative humidity and 23° C., of less than 10 cc/m²/day, and preferably less than 5 cc/m²/day.

In some embodiments, the barrier film has an oxygen transfer rate (OTR), measured according to the standard ASTM D-3985 at 85% relative humidity and 38° C., of less than 200 cc/m²/day, and preferably less than 150 cc/m²/day.

In some embodiments, the barrier film has a water vapor transfer rate (WVTR), measured according to the standard ASTM F1249 at 50% relative humidity and 23° C., of less than 10 g/m²/day, and preferably less than 5 g/m²/day.

The inventive barrier film will typically exhibit good resistance to grease and oil. Grease resistance of the barrier film is evaluated by the KIT-test according to standard ISO 16532-2. The test uses a series of mixtures of castor oil, toluene and heptane. As the ratio of oil to solvent is decreased, the viscosity and surface tension also decrease, making successive mixtures more difficult to withstand. The performance is rated by the highest numbered solution which does not darken the film sheet after 15 seconds. The highest numbered solution (the most aggressive) that remains on the surface of the paper without causing failure is reported as the “kit rating” (maximum 12). In some embodiments, the KIT value of the barrier film is at least 10, preferably 12, as measured according to standard ISO 16532-2.

There is a demand for improved solutions to replace aluminum foils and polyolefin films as barrier layers in packaging materials, such as liquid packaging board, with alternatives that facilitate re-pulping and recycling of the used packaging materials. The inventive barrier film can advantageously be manufactured almost entirely from biobased materials, and preferably from cellulose based materials, thereby facilitating re-pulping and recycling of used paper and paperboard based packaging materials comprising the barrier film. Such packaging materials, containing 95% by weight or more of cellulosic material, with the remaining 5% being other materials that will not affect recycling of the packaging material, are sometimes referred to as monomaterials.

In some embodiments, more than 95% by weight of the barrier film is cellulose based.

In embodiments, where both surfaces of the substrate have been subjected to vacuum coating, a protective coating layer may be disposed on one or both of the vacuum coated surfaces of the substrate.

The water-soluble polymer is applied in the form of an aqueous solution or dispersion onto the vacuum coating layer, and subsequently crosslinked and dried to form a thin protective coating layer. It is important that the dispersion or solution is homogeneous and stable, to result in an even coating with uniform barrier properties. Such dispersion coated layers may be made very thin, down to tenths of a gram per m², and may provide high quality, homogenous layers, provided the dispersion or solution is homogeneous and stable.

In some embodiments, the protective coating layer further comprises a pigment. In some embodiments, the protective coating layer further comprises a pigment in an amount of 1-30 wt %, preferably 1-20 wt %, more preferably 2-10 wt %, based on the total dry weight of the protective coating layer.

The inventive barrier film may preferably be used as a barrier layer in a paper or paperboard based packaging material, particularly in packaging board, liquid packaging board (LPB), paper pouches or paper or paperboard tubes or cups, for use in the packaging of liquids or liquid containing products. Therefore, according to a second aspect illustrated herein, there is provided a paper or paperboard based packaging material comprising:
a paper or paperboard base layer; and
a barrier film comprising:
a substrate;
a vacuum coating layer having a thickness in the range of 1-500 nm disposed on the substrate; and
a protective coating layer comprising a crosslinked water-soluble polymer disposed on the vacuum coating layer.

The barrier film of the paper or paperboard based packaging material according to the second aspect may be further defined as set out above with reference to the first aspect.

In some embodiments, the barrier film is laminated onto the base layer using an adhesive polymer layer disposed between the base layer and the barrier film. Thus, in some embodiments the paper or paperboard based packaging material further comprises an adhesive polymer layer disposed between the base layer and the barrier film.

In other embodiments, the substrate of the barrier film is a part of the paper or paperboard base layer. The substrate of the barrier film may for example have been laminated onto the base layer using an adhesive, or when MFC is used as the substrate, the MFC may have been wet laid onto the base layer.

The inventive barrier film or the paper or paperboard based packaging material is preferably realized without any extrusion coated or lamination coated polyolefin coatings often used in barrier layers for liquid packaging materials. Instead, the inventive barrier film preferably uses materials, which are more easily separated from the from the fibrous paper and paperboard materials and thereby facilitates re-pulping of the board. However, it is of course also possible to combine the inventive barrier film with a conventional extrusion coated or lamination coated polyolefin coating layer.

In some embodiments, the paper or paperboard base layer used in the paper or paperboard based packaging material has a basis weight in the range of 20-500 g/m², preferably in the range of 80-400 g/m².

In some embodiments, the paper or paperboard based packaging material is recyclable and has a reject rate according to PTS RH 021/97 of less than 30%, preferably less than 20%, more preferably less than 10%.

According to a third aspect illustrated herein, there is provided a container, particularly a liquid packaging container, comprising a barrier film according to the first aspect or a paper or paperboard based packaging material according to the second aspect.

According to a fourth aspect illustrated herein, there is provided a method for manufacturing a barrier film for a paper or paperboard based packaging material, comprising the steps of:
a) providing a substrate;
b) applying a vacuum coating layer having a thickness in the range of 1-500 nm on the substrate;
c) applying a coating solution comprising a water-soluble polymer to the vacuum coating layer; and
d) drying and crosslinking the water-soluble polymer with a crosslinking agent to obtain a protective coating layer comprising a crosslinked water-soluble polymer disposed on the vacuum coating layer.

The substrate, vacuum coating and protective coating layer may be further defined as set out above with reference to the barrier layer of the first aspect.

In some embodiments, the substrate comprises a microfibrillated cellulose layer (MFC layer).

In some embodiments, the water-soluble polymer of the protective coating layer is selected from the group consisting of a polyvinyl alcohol, a modified polyvinyl alcohol, and a polysaccharide, or combinations thereof.

In some embodiments, the water-soluble polymer of the protective coating layer is a polyvinyl alcohol.

In some embodiments, the water-soluble polymer of the protective coating layer is crosslinked by a multifunctional carboxylic acid crosslinking agent. In some embodiments, the multifunctional carboxylic acid is selected from the group consisting of citric acid, malic acid, succinic acid, tartaric acid, and 1,2,3,4-butanetetracarboxylic acid, or a combination thereof. In a preferred embodiment, the multifunctional carboxylic acid is citric acid.

It is also possible to use a higher molecular weight polycarboxylic acid as the crosslinking agent. Examples of such higher molecular weight polycarboxylic acids include, but are not limited to polymaleic acid and poly(methyl vinyl ether-co-maleic acid).

In some embodiments, the crosslinking agent is a carboxylic acid functional crosslinking agent, preferably citric acid.

The crosslinker may be buffered with a base, such as NaOH or KOH, to slightly higher pH.

In some embodiments, the crosslinking pH is below 7, preferably in the range of 3-7, more preferably in the range of 3.5-6.5.

The amount of the crosslinking agent is preferably in the range of 5-50 wt % based on the weight of the water-soluble polymer, more preferably in the range of 10-40 wt % based on the weight of the water-soluble polymer.

Drying can for example be achieved using hot air, IR radiation, or a combination thereof. In some embodiments, the drying and/or crosslinking in step d) is performed at a temperature in the range of 55-200° C., preferably in the range of ° C. In some embodiments, the drying and/or crosslinking in step d) is performed at a temperature in the range of 55-120° C., preferably in the range of ° C.

In some embodiments, the method further comprises laminating the barrier film or the substrate of the barrier film onto a paper or paperboard base layer

In some embodiments, the substrate in step a) is provided on a paper or paperboard base layer.

The inventive barrier film or paper or paperboard based packaging material comprising the inventive barrier film may be provided with an additional polymer layer on one side or on both sides. The additional polymer layer may of course interfere with repulpability, but may still be required or desired in some applications. The additional polymer layers may for example be applied by extrusion coating, film lamination or dispersion coating.

The additional polymer layer may comprise any of the thermoplastic polymers commonly used in paper or paperboard based packaging materials in general or polymers used in liquid packaging board in particular. Examples include polyethylene (PE), polyethylene terephthalate (PET), polypropylene (PP), polyhydroxyalkanoates (PHA), polylactic acid (PLA), polyglycolic acid (PGA), starch and cellulose. Polyethylenes, especially low density polyethylene (LDPE) and high density polyethylene (HDPE), are the most common and versatile polymers used in liquid packaging board.

Thermoplastic polymers are useful since they can be conveniently processed by extrusion coating techniques to form very thin and homogenous films with good liquid barrier properties. In some embodiments, the additional polymer layer comprises polypropylene or polyethylene. In preferred embodiments, the polymer layer comprises polyethylene, more preferably LDPE or HDPE.

In some embodiments, the additional polymer layer is formed by extrusion coating of the polymer onto a surface of the barrier film. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each additional polymer layer is preferably less than 50 g/m². In order to achieve a continuous and substantially defect free film, a basis weight of the additional polymer layer of at least 8 g/m², preferably at least 12 g/m² is typically required. In some embodiments, the basis weight of the additional polymer layer is in the range of 8-50 g/m², preferably in the range of 12-50 g/m².

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

In order to evaluate the barrier film of the invention, a test was performed in which the oxygen transmission rates (OTR) and the water vapor transmission rates (WVTR) of the inventive films were compared to a reference film.

### Example 1. Uncoated MFC Film (Reference)

An uncoated 32 gsm MFC and soft nip calandered film was prepared using a wet laid technique in a fourdrinier paper machine. The furnish contained MFC (SR>94), The raw material used for the MFC film was bleached kraft pulp. The moisture content of the film was about 4 wt %, The Gurley-Hill value of the film was 42 300 s/100 ml (determined according to the standard ISO 5636/6, max value for the device).

The OTR was measured with a Mocon Oxtran 2/22 device according to the standard ASTM D-3985 at 50% relative humidity and 23° C. The OTR of the film was 9117 and 5955 cc/m²/day at 23° C. and 50% relative humidity (referred to herein as 23° C./50RH). OTR was not measurable at tropical conditions of 38° C. and 85% relative humidity (referred to herein as 38° C./85RH).

The WVTR for the corresponding sample was measured with a Mocon Permatran 3/34 according to the standard ASTM F1249. The WVTR was too high to be measured both at 23° C./50RH and 38° C./85RH.

### Example 2. Metallized MFC Film (Reference)—Direct Metallization

The film of example 1 was used as substrate. The substrate was subjected to vacuum metallization by physical vapor deposition with aluminum metal using a standard device which is also used for metallization of paper.

The targeted aluminum coat weight was estimated to about 100 mg/m² or about 30-40 nm.

After the metallization, the OTR of the film was 126 and 33 cc/m²/day at 23° C./50RH when measured with Macon Oxtran 2/22 device according to the standard ASTM D-3985.

The WVTR values for the metallized film was 116 and 113 g/m²/day at 23° C./50RH.

This shows that the metallization improved the OTR and also WVTR, although the levels were still not sufficient for industrial applications.

### Example 3. Metallized MFC Film with Non-Crosslinked PVOH Coating

In this case the above sample was metallized and then post coated with PVOH (Poval 6-88, Kuraray) using a rod coater. The PVOH coat weight was estimated to be about 10 gsm.

The OTR of the PVOH coated film was significantly improved. The OTR of the PVOH coated film was 2.8 and 1.4 cc/m²/day (23° C./50RH) and 102 and 116 cc/m²/day (38° C./85RH).

The corresponding WVTR was 10.8 and 9.1 g/m²/day (2° C./50RH) and 575 and 648 g/m²/day (38° C./85RH) confirming that WVTR was improved.

### Example 4. Metallized MFC Film with Crosslinked PVOH Coating (Invention)

In this case, an aqueous coating solution of PVOH (Poval 6-88, Kuraray) and citric acid (CA) was prepared. The PVOH concentration was 14.5 wt %, and the citric acid concentration was 25 wt % of the PVOH concentration. The pH of the coating solution was about 2. The coating solution was applied in a similar manner as in Example 3 and the sample was dried at room temperature. The dry basis weight of the coating was estimated to be about 10 gsm.

The OTR of the PVOH coated film was significantly improved. The OTR of the PVOH/CA coated film was 2.6 and 1.4 cc/m²/day (23° C./50RH) and 99 and 144 cc/m²/day (38° C./85RH).

The corresponding WVTR was 4.5 and 4.8 g/m²/day (23° C./50RH) and 615 and 706 g/m²/day g/m²/day (38° C./85RH) confirming that WVTR was improved significantly, especially at 23° C./50RH.

### Example 5. Metallized MFC Film with Non-Crosslinked PVOH Foam Coating

In this case, a PVOH solution as used in Example 3 was prepared into a foam in order to simulate a lower solvent and more soft application of the coating. Foaming was achieved by mixing air into the PVOH solution during continuous mixing. The density of the foam was about 40 g/100 ml. The foam was applied to the metallized MFC film using a rod coater. The foam coating gave a more even substrate and less water induced wrinkling and swelling compared to liquid coating. The dry basis weight of the coating was less than in Example 3.

The OTR of the PVOH foam coated film was significantly improved. The OTR of the PVOH foam coated film was 1.4 and 1.8 cc/m²/day (23° C./50RH) and 66 cc/m²/day (38° C./85RH).

The corresponding WVTR was 6.9 and 1.3 g/m²/day (23° C./50RH) and 4 g/m²/day (38° C./85RH).

### Example 6. Metallized MFC Film with Crosslinked PVOH Foam Coating (Invention)

In this case, a PVOH solution as used in Example 4 was prepared into a foam with CA in order to simulate a solvent less and more soft application of the coating. Foaming was achieved by mixing air into a PVOH solution during continuous mixing. Density of the foam was about 40 g/100 ml. The foam was applied to the metallized MFC film using a rod coater. The coating gave more even substrate and less water induced wrinkling and swelling compared to liquid coating.

The OTR of the PVOH coated film was significantly improved. The OTR of the PVOH/CA coated film was 0.8 cc/m²/day (23° C./50RH) and WVTR was 10.6 g/m²/day (23° C./50RH).

### Example 7. Metallized MFC Film with Crosslinked PVOH Foam Coating and Drying at Elevated Temperature (Invention)

A sample of the film obtained in Example 6 was further dried/cured in an oven at 150° C. for 5 min.

The OTR of the film after curing was 0.8 and 7.2 cc/m²/day (23° C./50RH) and 20 cc/m²/day (38° C./85RH).

The WVTR of the film after curing was 3.5 and 7 g/m²/day (23° C./50RH) and 35 g/m²/day (38° C./85RH).

The results confirmed that the barrier properties, and especially WVTR, can be further improved by curing at elevated temperature.

1. A barrier film for a paper or paperboard-based packaging material, said barrier film comprising:
a substrate;
a vacuum coating layer having a thickness in a range of 1-500 nm disposed on the substrate; and
a protective coating layer comprising a crosslinked water-soluble polymer disposed on the vacuum coating layer.

2. The barrier film according to claim 1, wherein the substrate comprises less than 10 pinholes/m².

3. The barrier film according to claim 1, wherein the substrate consists of or comprises a microfibrillated cellulose layer (MFC layer).

4. The barrier film according to claim 3, wherein the MFC layer comprises at least 50 wt %, MFC, based on a total dry weight of the MFC layer.

5. The barrier film according to claim 3, wherein the MFC layer comprises polyvinyl alcohol (PVOH).

6. The barrier film according to claim 3, wherein a basis weight of the MFC layer is in a range of less than 55 gsm.

7. The barrier film according to claim 3, wherein the substrate comprises the MFC layer and further comprises a precoat layer disposed between the MFC layer and the vacuum coating layer.

8. The barrier film according to claim 7, wherein the precoat layer comprises a water-soluble polymer selected from a group consisting of: a polyvinyl alcohol, a modified polyvinyl alcohol, and a polysaccharide, and combinations thereof.

9. The barrier film according to claim 7, wherein a basis weight of the precoat layer is in a range of 0.1-12 gsm.

10. The barrier film according to claim 1, wherein the vacuum coating layer is formed by vapor deposition of a metal or metal oxide on the substrate.

11. The barrier film according to claim 1, wherein the vacuum coating layer comprises a metal or metal oxide selected from a group consisting of: aluminum, magnesium, silicon, copper, aluminum oxides, magnesium oxides, silicon oxides, and combinations thereof.

12. The barrier film according to claim 1, wherein the vacuum coating layer has a layer thickness in a range of 1-100 nm.

13. The barrier film according to claim 1, wherein the water-soluble polymer of the protective coating layer is selected from a group consisting of: a polyvinyl alcohol, a modified polyvinyl alcohol, and a polysaccharide, and combinations thereof.

14. The barrier film according to claim 1, wherein the water-soluble polymer of the protective coating is crosslinked by a multifunctional carboxylic acid crosslinking agent.

15. The barrier film according to claim 1, wherein a basis weight of the protective coating layer is in a range of 0.1-12 gsm.

16. The barrier film according to claim 1, wherein the barrier film comprises an oxygen transfer rate (OTR), measured according to the standard ASTM D-3985 at 50% relative humidity and 23° C., of less than 10 cc/m²/day.

17. The barrier film according to claim 1, wherein the barrier film comprises an oxygen transfer rate (OTR), measured according to the standard ASTM D-3985 at 85% relative humidity and 38° C., of less than 200 cc/m²/day.

18. The barrier film according to claim 1, wherein the barrier film comprises a water vapor transfer rate (WVTR), measured according to the standard ASTM F1249 at 50% relative humidity and 23° C., of less than 10 g/m²/day.

19. The barrier film according to claim 1, wherein more than 95% by weight of the barrier film is cellulose based.

20. A paper or paperboard based packaging material comprising:
a paper or paperboard base layer; and
a barrier film according to claim 1.

21. The paper or paperboard based packaging material according to claim 20, wherein the paper or paperboard has a basis weight in a range of 20-500 g/m².

22. The paper or paperboard based packaging material according to claim 20, the paper or paperboard based packaging material comprising a reject rate according to PTS RH 021/97 of less than 30%.

23. A container comprising a barrier film according to claim 1.

24. A method for manufacturing a barrier film for a paper or paperboard based packaging material, comprising the steps of:
a) providing a substrate;
b) applying a vacuum coating layer having a thickness in a range of 1-500 nm on the substrate;
c) applying a coating solution comprising a water-soluble polymer to the vacuum coating layer; and
d) drying and crosslinking the water-soluble polymer with a crosslinking agent to obtain a protective coating layer comprising a crosslinked water-soluble polymer disposed on the vacuum coating layer.

25. The method according to claim 24, wherein the substrate comprises a microfibrillated cellulose layer (MFC layer).

26. The method according to claim 24, wherein the water-soluble polymer of the protective coating layer is selected from the group consisting of a polyvinyl alcohol, a modified polyvinyl alcohol, a polysaccharide, and combinations thereof.

27. The method according to claim 24, wherein the crosslinking agent is a carboxylic acid functional crosslinking agent.

28. The method according to claim 24, wherein the crosslinking pH is below 7.
